(19) United States
(12) Patent Application Publication
(10) Pub. No.: US 2013/0250077 A1
(43) Pub. Date: Sep. 26, 2013

(54) IMAGE PROCESSING APPARATUS, IMAGE PROCESSING METHOD AND COMPUTER PROGRAM

(71) Applicant: SONY CORPORATION, Tokyo (JP)

(72) Inventors: Takaomi KIMURA, Tokyo (JP); Daisuke MOCHIZUKI, Chiba (JP); Junko FUKUDA, Kanagawa (JP)

(73) Assignee: SONY CORPORATION, Tokyo (JP)

(21) Appl. No.: 13/753,947

(22) Filed: Jan. 30, 2013

(30) Foreign Application Priority Data
Mar. 26, 2012 (JP) 2012069102

(51) Int. Cl. H04N 9/80

(52) U.S. Cl. CPC H04N 9/80
USPC 348/61

(57) ABSTRACT

There is provided an image processing apparatus including an effect interval setting unit setting multiple effect intervals in a predetermined interval to continuously display image data, an image assigning unit assigning the image data to each of the multiple effect intervals, an effect setting unit setting an effect to each of the multiple effect intervals, an effect resetting deciding unit deciding whether the effect satisfies a condition to realize each effect, using image metadata corresponding to image data assigned, and causing the effect setting unit to reset an effect in an effect interval in a case where the effect interval does not satisfy the condition, and a consistency deciding unit deciding, in a case where the effect resetting deciding unit causes the effect setting unit to reset the effect, a consistency between an effect interval in which the effect is reset and a different effect interval.

### BACKGROUND

The present disclosure relates to an image processing apparatus, an image processing method and a computer program.

There is disclosed a technique of sequentially switching and displaying multiple pictures while playing music, and generating content called “slide show.” In the case of automatically creating a slide show, although there is a mainstream technique of applying an image to a template prepared in advance, there are problems that some images are not applicable to an image display effect (i.e. image effect) determined in the template and an optimal image effect for an image cannot be selected. There are disclosed techniques of solving such problems (see Japanese Patent Laid-Open No. 2008-084021, Japanese Patent Laid-Open No. 2007-243411, Japanese Patent Laid-Open No. 2005-210350).

Japanese Patent Laid-Open No. 2008-084021 discloses a technique of automatically creating a higher-quality slide show synchronized with music by creating a display template based on music analysis and optimally selecting an assigned image and a cutout area. Japanese Patent Laid-Open No. 2007-243411 discloses a technique of selecting a more optimal image or area by using area extraction information in the image at the time of applying the image to a slide-show template. Also, Japanese Patent Laid-Open No. 2005-210350 discloses a technique of determining a requested playback music period from a combination of an image and an image effect and automatically creating a slide show in which the image effect is synchronized with music.

### SUMMARY

However, in the technique disclosed in Japanese Patent Laid-Open No. 2008-084021, an advantage is not provided in a case where there is no image corresponding to an image effect requested to be used, and the perfection level as a slide show decreases. In the technique disclosed in Japanese Patent Laid-Open No. 2007-243411, it may be inconsistent depending on the anteroposterior relationships of selected images and image effects, and the quality of the whole slide show decreases. Also, in the technique disclosed in Japanese Patent Laid-Open No. 2005-210350, an image effect is switched at a different timing from a timing at which the image effect is essentially requested to be musically switched, and, for example, the same image effect continues even at the timing “B” melody shifts to the hook.

Therefore, the present disclosure provides a new improved image processing apparatus, image processing method and computer program that can recursively determine an optimal combination of music and images at the time of automatic creation of a slide show and improve the quality of the slide show.

According to an embodiment of the present disclosure, there is provided an image processing apparatus including an effect interval setting unit setting multiple effect intervals in a predetermined interval to continuously display image data, an image assigning unit assigning the image data to each of the multiple effect intervals set by the effect interval setting unit, an effect setting unit setting an effect to each of the multiple effect intervals set by the effect interval setting unit, an effect resetting deciding unit deciding whether the effect set with respect to each of the multiple effect intervals by the effect setting unit satisfies a condition to realize each effect, using image metadata corresponding to image data assigned by the image assigning unit, and causing the effect setting unit to reset an effect in an effect interval in a case where the effect interval does not satisfy the condition, and a consistency deciding unit deciding, in a case where the effect resetting deciding unit causes the effect setting unit to reset the effect, a consistency between an effect interval in which the effect is reset and a different effect interval.

With such a configuration, an effect interval setting unit sets multiple effect intervals in a predetermined interval to continuously display image data and an image assigning unit assigns the image data to each of the multiple effect intervals set by the effect interval setting unit. An effect setting unit sets an effect to each of the multiple effect intervals set by the effect interval setting unit, and an effect resetting deciding unit decides whether the effect set with respect to each of the multiple effect intervals by the effect setting unit satisfies a condition to realize each effect, using image metadata corresponding to image data assigned by the image assigning unit, and causing the effect setting unit to reset an effect in an effect interval in a case where the effect interval does not satisfy the condition Also, in a case where the effect resetting deciding unit causes the effect setting unit to reset the effect, a consistency deciding unit decides a consistency between an effect interval in which the effect is reset and a different effect interval. As a result, the image processing apparatus can recursively determine an optimal combination of music and images at the time of automatic creation of a slide show and improve the quality of the slide show.

According to an embodiment of the present disclosure, there is provided an image processing method including an effect interval setting operation setting multiple effect intervals in a predetermined interval to continuously display image data, an image assigning operation assigning the image data to each of the multiple effect intervals set by the effect interval setting operation, an effect setting operation setting an effect to each of the multiple effect intervals set by the effect interval setting operation, an effect resetting deciding operation deciding whether the effect set with respect to each of the multiple effect intervals in the effect setting operation satisfies a condition to realize each effect, using image metadata corresponding to image data assigned in the image assigning operation, and causing an effect in an effect interval to be reset in a case where the effect interval does not satisfy the condition, and a consistency deciding operation deciding, in a case where the effect resetting deciding operation causes the effect setting operation to reset the effect, a consistency between an effect interval in which the effect is reset and a different effect interval.

According to an embodiment of the present disclosure, there is provided an computer program that causes a computer to execute an effect interval setting operation setting multiple effect intervals in a predetermined interval to continuously display image data, an effect setting operation setting an effect to each of the multiple effect intervals set by the effect interval setting operation, an image assigning operation assigning the image data to each of the multiple effect intervals set by the effect interval setting operation, an effect resetting deciding operation deciding whether the effect set with respect to each of the multiple effect intervals in the effect setting operation satisfies a condition to realize each effect, using image metadata corresponding to image data assigned in the image assigning operation, and causing an effect in an effect interval to be reset in a case where the effect interval does not satisfy the condition, and a consistency deciding operation deciding, in a case where the effect resetting deciding operation causes the effect setting operation to reset the effect, a consistency between an effect interval in which the effect is reset and a different effect interval.

According to an embodiment of the present disclosure described above, it is possible to provide a new improved image processing apparatus, image processing method and computer program that can recursively determine an optimal combination of music and images at the time of automatic creation of a slide show and improve the quality of the slide show.

### BRIEF DESCRIPTION OF THE DRAWINGS

FIG. 1 is an explanatory diagram illustrating a functional configuration of an image processing apparatus 100 according to an embodiment of the present disclosure;

FIG. 2 is an explanatory diagram illustrating a state where music feature amounts are acquired using a twelve-tone analysis technique;

FIG. 3 is an explanatory diagram illustrating a relationship example between the musical theory and chord progression;

FIG. 4 is an explanatory diagram illustrating slide-show theme examples;

FIG. 5 is an explanatory diagram illustrating an example of setting effect intervals of a slide show;

FIG. 6 is an explanatory diagram illustrating an example of a tree structure formed by event clustering and similarity analysis result;

FIG. 7 is a diagram illustrating a state where, at the time of automatic creation of a slide show, an optimal combination between music and images is recursively determined so as to improve the quality of the slide show;

FIG. 8 is an explanatory diagram illustrating an example of processing of assigning images to effect intervals;

FIG. 9 is an explanatory diagram illustrating an example of resetting effects;

FIG. 10 is an explanatory diagram illustrating an example of reset effects;

FIG. 11 is an explanatory diagram illustrating an example of selecting an image from candidate images;

FIG. 12 is an explanatory diagram illustrating an example of cutting out a display range by a display range cutout unit 124;

FIG. 13 is an explanatory diagram illustrating an example of realizing an effect of using multiple images from one image;

FIG. 14 is an explanatory diagram illustrating an example of animation in which parameters are set;

FIG. 15 is an explanatory diagram illustrating an example of animation in which parameters of key frames are set;

FIG. 16 is an explanatory diagram illustrating a setting example of information to decorate a slide show;

FIG. 17 is a flowchart illustrating operations of an image processing apparatus 100 according to an embodiment of the present disclosure;

FIG. 18 is an explanatory diagram illustrating an example of selecting an effect suitable to music;

FIG. 19 is an explanatory diagram illustrating an example of selecting an effect suitable to music;

FIG. 20 is an explanatory diagram illustrating an example of correspondence relationships between melodies and effects;

FIG. 21 is an explanatory diagram illustrating a detection example of partial modulation; and

FIG. 22 is an explanatory diagram illustrating another detection example of partial modulation.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, an explanation will be given in the following order.

### <1. Embodiment of the Present Disclosure>

### [Functional Configuration of Image Processing Apparatus]

### <2. Summary>

### <1. Embodiment of the Present Disclosure>

### [Functional Configuration of Image Processing Apparatus]

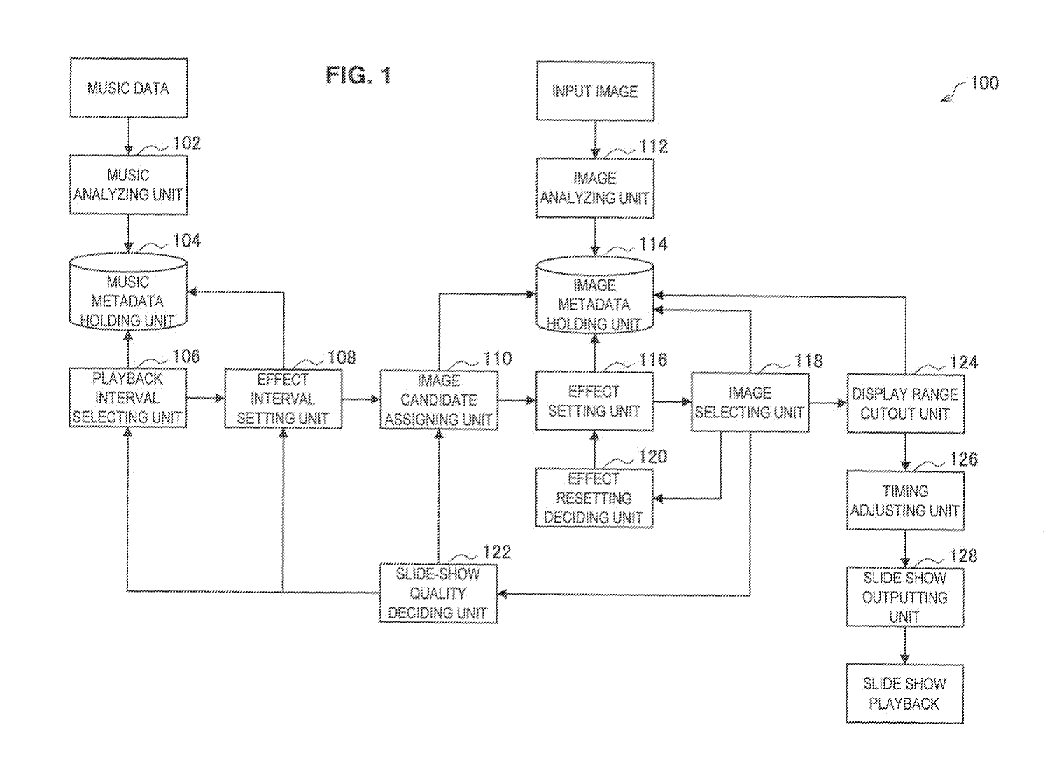

First, a functional configuration of an image processing apparatus according to an embodiment of the present disclosure will be explained with reference to the drawings. FIG. 1 is an explanatory diagram illustrating a functional configuration of an image processing apparatus 100 according to an embodiment of the present disclosure. In the following, the functional configuration of the image processing apparatus 100 according to an embodiment of the present disclosure will be explained using FIG. 1.

The image processing apparatus 100 illustrated in FIG. 1 denotes an apparatus having a function of automatically generating a slide show from image data and music data. Here, the “slide show” indicates content of sequentially switching and displaying multiple pictures while playing music.

As illustrated in FIG. 1, the image processing apparatus 100 according to an embodiment of the present disclosure employs a configuration including a music analyzing unit 102, a music metadata holding unit 104, a playback interval selecting unit 106, an effect interval setting unit 108, an image candidate assigning unit 110, an image analyzing unit 112, an image metadata holding unit 114, an effect setting unit 116, an image selecting unit 118, an effect resetting deciding unit 120, a slide-show quality deciding unit 122, a display range cutout unit 124, a timing adjusting unit 126 and a slide show outputting unit 128.

The music analyzing unit 102 analyzes music data and outputs an analysis result as metadata. The metadata output by analyzing the music data played in a slide show is used to cut out a playback interval by the playback interval selecting unit 106, which will be described later, and set an image effect suitable to the music by the effect interval setting unit 108. The music analyzing unit 102 outputs the metadata acquired by analyzing the music data to the music metadata holding unit 104. The music metadata holding unit 104 holds the music metadata acquired by analyzing the music data in the music analyzing unit 102. The music metadata held by the music metadata holding unit 104 is referred to from the playback interval selecting unit 106 and the effect interval setting unit 108.

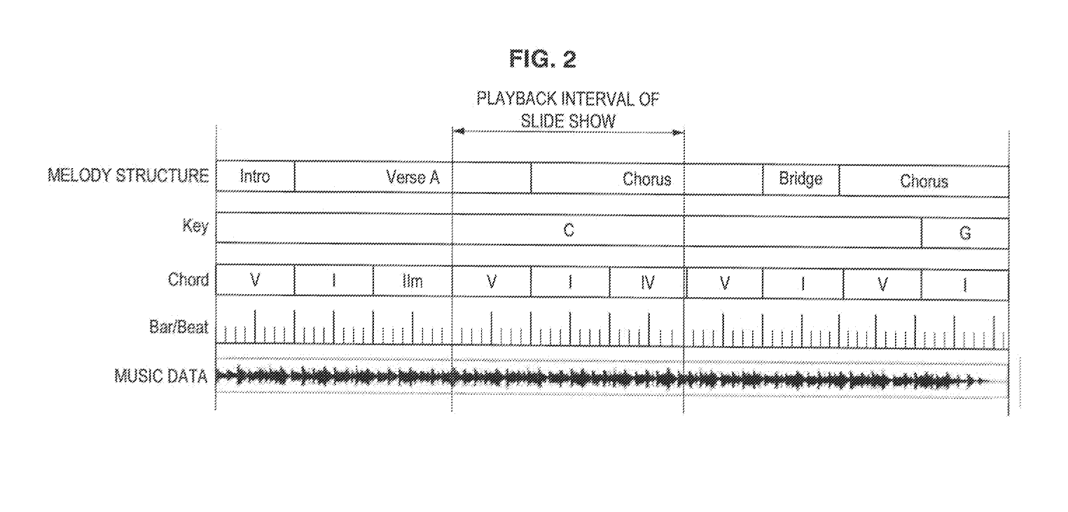

The present embodiment utilizes a twelve-tone analysis technique of a melody analysis algorithm in order to create a slide show in synchronization with music. FIG. 2 is an explanatory diagram illustrating a state where music feature amounts are acquired using the twelve-tone analysis technique. As illustrated in FIG. 2, by the twelve-tone analysis technique, it is possible to acquire music feature amounts including: a music structure such as the hook and “A” melody; a key indicating a music interval; a chord indicating a chord sound; a position of musical time or beat; and the beat intensity. In order to determine an effect switching timing or the like later, the music analyzing unit 102 extracts and acquires these music feature amounts.

The playback interval selecting unit 106 selects a playback interval in the played music data, using the music metadata of the music data played in the slide show, where the music metadata is held in the music metadata holding unit 104. The playback interval selecting unit 106 supplies information of the selected playback interval to the effect interval setting unit 108.

In a slide show synchronized with music, there is a case where pictures are played in synchronization with one item of music or played over multiple items of music, but, in a case where the number of pictures is small or it is requested to be sent to parents or friends by a mobile phone as a motion picture, there is a case where it is requested to create a short slide show with respect to part of one item of music. In such a case, using music feature amounts acquired by the twelve-tone analysis technique, the playback interval selecting unit 106 may cut out part of the music data such as an interval of 30 seconds from a position slightly before the hook, as a slide-show playback interval. FIG. 2 illustrates a case where part of the music is set as a slide-show playback interval.

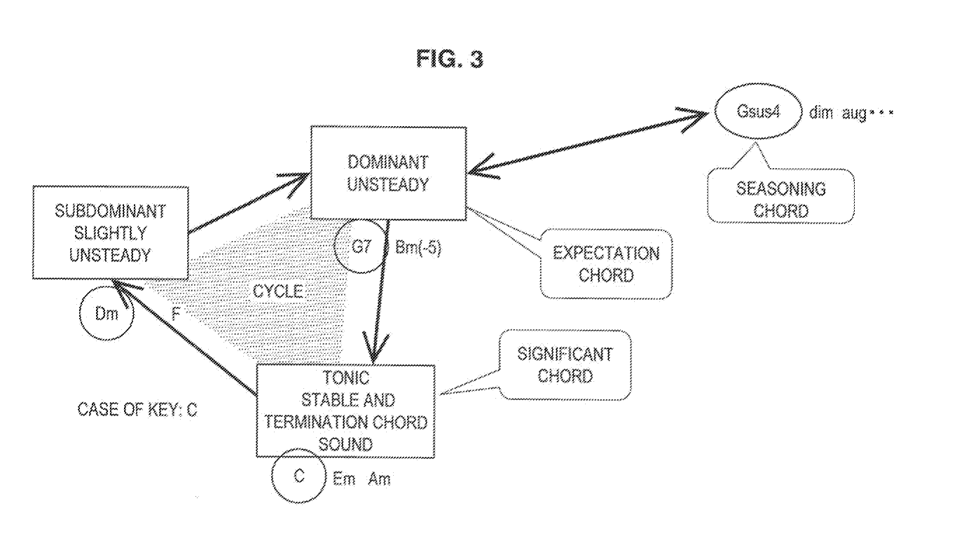

Also, there is a case where chord information acquired by twelve-tone analysis in the music analyzing unit 102 and its chord progression are characteristic in the musical theory. For example, in the musical theory, there are a slightly unsteady chord sound called “subdominant,” an unsteady chord sound called “dominant” and a steady chord sound called “tonic.” FIG. 3 is an explanatory diagram illustrating a relationship example between the musical theory and chord progression.

Among these chord sounds, in the case of progression of transition from the dominant to the tonic, since there is provided an impressive pattern to cause a listener to feel uneasy and then feel reassured, an effect of improving the power of expression by combining an effect in the slide show is expected. In addition to the above, regarding an area in which the chord is often switched and an area in which unique chord sounds or beats to capture listener's attention are concentrated, they can be effectively used at the time of automatically creating a slide show. Therefore, the playback interval selecting unit 106 may hold and supply such area information to the effect interval setting unit 108.

The effect interval setting unit 108 sets multiple effect intervals from predetermined intervals to continuously display image data as a slide show. For example, the effect interval setting unit 108 sets image effect intervals in the playback interval of the music data supplied from the playback interval selecting unit 106, using the music metadata of the music data played in the slide show, where the music metadata is held in the music metadata holding unit 104. The effect interval setting unit 108 supplies information of the set effect intervals to the image candidate assigning unit 110.

In the present embodiment, main factors to determine the effect intervals in the effect interval setting unit 108 are the following four items in order of priority.

### (1) Essential Effect Interval Every Theme

When determining an effect interval, first, the effect interval setting unit 108 prioritizes an essential effect interval every set theme. Here, the theme denotes something like the world view of a slide show and is set by the user to automatically create the slide show, for example.

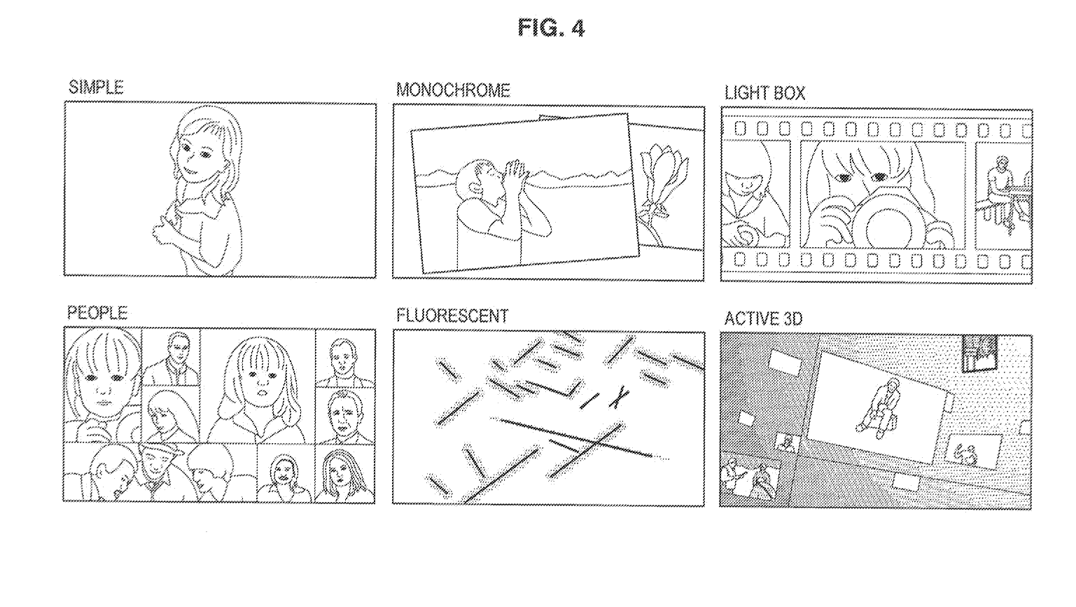

FIG. 4 is an explanatory diagram illustrating slide-show theme examples. FIG. 4 illustrates a simple slide show, a slide show of black and white images, a slide show to provide pictures on a film, a slide show in which an image effect focusing person's faces is main, a slide show in which pictures waft in the space, and a slide show using 3D, and the slide-show atmosphere largely changes between the different themes. Here, unlike a simple template, in these slide shows, the themes themselves do not have an effect switching timing.

Some themes provide specific image effects such as an intro and ending, and these effect intervals are determined with a top priority. Those specific image effects may be a constant number of seconds or the first bar, and vary depending on the theme or effect type.

### (2) Switching Timing of Music Structure

Next, when determining an effect interval, the effect interval setting unit 108 prioritizes the timing at which the music structure switches in music metadata. Examples of the switching timing of the music structure include the switching of beat (4/4 to 3/4), a change of key (e.g. C to G) and the switching of melody (e.g. “B” melody to the hook). Since the musical atmosphere largely changes at these timings, it is effective to switch image effects at those timings.

At the time of using a switching timing of the music structure, the effect interval setting unit 108 does not determine an effect interval itself, and, after that, when an effect interval over that timing is set, the effect is preferentially cut at the switching timing of the music structure.

(3) Impressive Area with Respect to Chord Progression

Although an impressive chord progression pattern and a characteristic chord sound are extracted in the above explanation of music metadata, next, at the time of determining an effect interval, the effect interval setting unit 108 preferentially utilizes an area having the chord progression pattern and the characteristic chord sound, as an effect interval. At the time of application of the chord progression pattern and the characteristic chord sound, the effect interval setting unit 108 may vary it depending on the theme or the music structure (e.g. hook and “A” melody) at that timing.

### (4) Based Switching Pattern Every Theme

Factors (1) to (3) may not be provided depending on the theme or music. In such a case, if the effect interval setting unit 108 sets effect intervals at regular intervals (e.g. in units of one bar), the slide show may be monotonous.

Therefore, at the time of determining effect intervals, the effect interval setting unit 108 sets a based effect interval at various intervals or timings. These intervals or timings vary depending on the theme set in the slide show, and may be set in consideration of music mood feature amounts acquired by analyzing music data. The effect interval setting unit 108 may change effect intervals or effect switching timings depending on the music structure, for example, it sets the effect intervals at short intervals in the hook part of music and sets the effect intervals at long intervals in the bridge part. Thus, by changing the effect intervals and effect switching timings depending on the music structure, an advantage of not making the slide show monotonous is provided.

Also, since there are many cases where music repeats or changes a structure in units of four bars, eight bars or sixteen bars, it is more effective to reflect such knowledge to the setting of effect intervals by the effect interval setting unit 108.

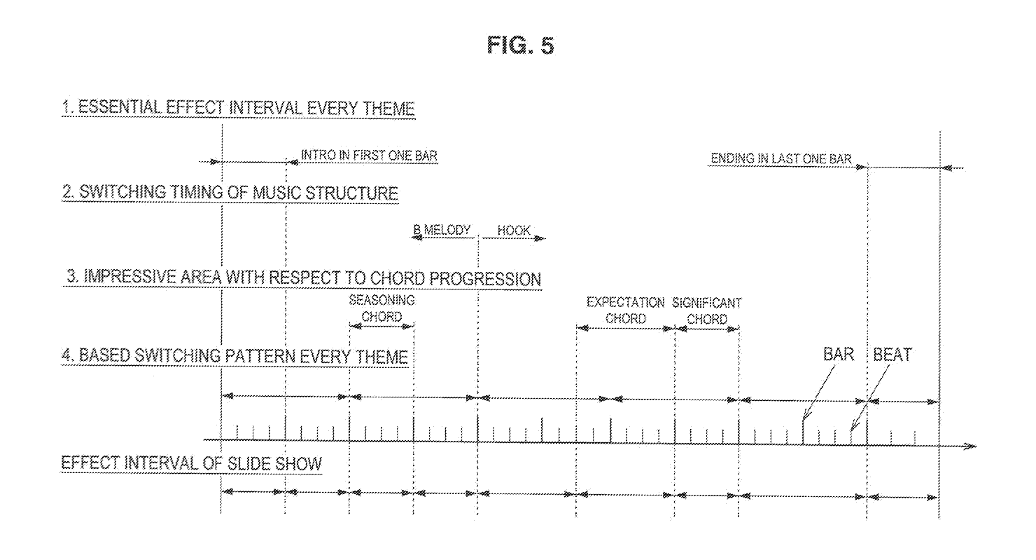

FIG. 5 is an explanatory diagram illustrating an example where the effect interval setting unit 108 sets effect intervals of a slide show in the above priority order of (1) to (4). Although these effect intervals illustrated in FIG. 5 may be reset later, first, the effect intervals set herein are used as a framework, and subsequent image assignment and effect setting are performed.

The image candidate assigning unit 110 assigns the image to each effect interval set in the effect interval setting unit 108, from an image group prepared to display a slide show. The image assignment to each effect interval by the image candidate assigning unit 110 will be described later in detail.

The image analyzing unit 112 performs image analysis processing on the image group prepared to display the slide show. With respect to the image group prepared to display the slide show, the image analyzing unit 112 acquires analysis feature amounts related to faces, similarity and colors and feature amounts such as general Exif information, and generates and holds various-granularity groups so as to be easy to use when the image candidate assigning unit 110 assigns the image used for the slide show to each effect interval. The image analyzing unit 112 outputs image metadata acquired as a result of the image analysis processing to the image metadata holding unit 114. The image metadata holding unit 114 holds the image metadata output by the image analyzing unit 112. The image metadata held by the image metadata holding unit 114 is referred to by the effect setting unit 116, the image selecting unit 118, the display range cutout unit 124, and so on.

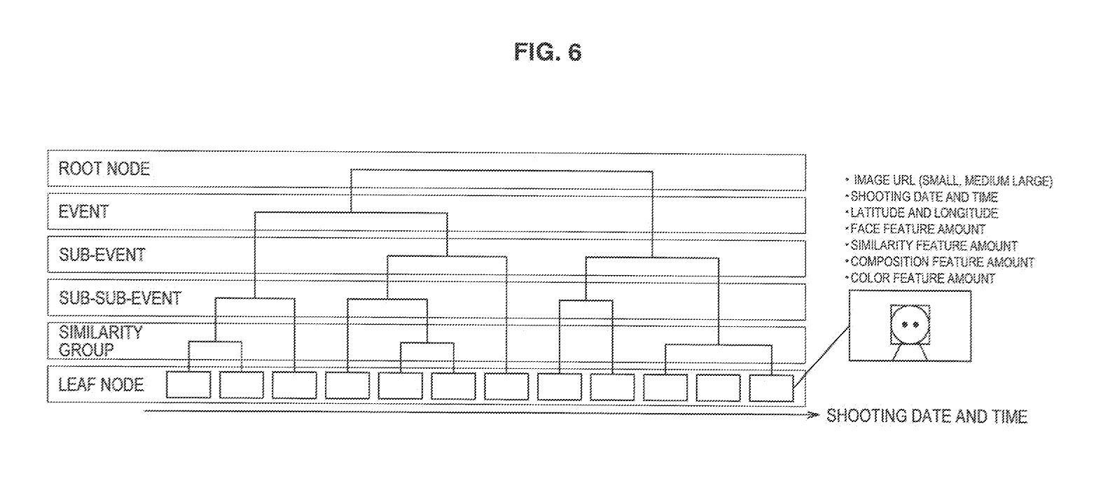

In a slide show, since there are many cases where images are displayed in order of the shooting date and time, for example, if a tree is formed in advance using the event clustering disclosed in Japanese Patent Laid-Open No. 2007-94762 or a similarity analysis result, it becomes easy to use images in subsequent processing. FIG. 6 is an explanatory diagram illustrating an example of a tree structure formed by event clustering and similarity analysis result, with respect to an image group. The similarity analysis may use information such as the image URL, the image size, the shooting date and time, the latitude and longitude of imaged images, the face feature amount, the similarity feature amount, the composition feature amount and the color feature amount.

Also, instead of the order of shooting date and time, a group generation may be performed using a face detection or face identification technique. For example, Japanese Patent Laid-Open No. 2011-133988 discloses a technique of grouping characters or generating a group based on human relations.

The effect setting unit 116 sets the effect to each effect interval set in the effect interval setting unit 108. The effect setting unit 116 sets the first expected effect to each effect interval set in the effect interval setting unit 108. Here, the expression “expected” is used because, although it is an optimal effect to express a designated theme or an excitation of music, in a case where an unsuitable effect is provided to an assigned image or there is a bad linkage between consecutive effects when these effects are reset, the effect may be changed. First, the effect setting unit 116 is caused to set an effect that is likely to be optimal as a slide show, and, if a change is requested, the effect setting unit 116 is caused to reset the effect. Conditions of selecting the effect type conform to the above setting method of effect intervals.

### (1) Essential Effect Interval Every Theme

In an effect interval determined every theme, an unconditionally suitable effect is set. The effect interval determined every theme denotes, for example, the intro part or ending part of a slide show.

### (2) Switching Timing of Music Structure

At this music structure switching timing, although effect intervals are not set in the effect interval setting unit 108, it has a role of setting an effect type assigned immediately after the switching of the music structure. At this timing, the effect setting unit 116 is used to emphasize an excitation by, for example, assigning a dramatic effect immediately after the switching from “B” melody to the hook or by assigning an effect to flash the entire screen.

(3) Impressive Area with Respect to Chord Progression

In this impressive area with respect to chord progression, the effect setting unit 116 assigns a significant effect in the musical theory. For example, the effect setting unit 116 selects a decorative effect in the case of a specific chord sound to attract audience's attention, a bridge effect so as to be expected later in the case of an unsteady chord sound, a dramatic effect so as to be significant in a slide show in the case of a steady chord sound, and an active effect in the case of an interval in which the chord is often switched. Thus, by setting effects according to chord progression, the image processing apparatus 100 according to the present embodiment can realize an attractive slide show that is more suitable to music by overlapping a musical impression and a visual impression.

### (4) Based Switching Pattern Every Theme

In this based pattern, the effect setting unit 116 sets effects taking into consideration that various effects occur, the same effect does not continue and more related effects are arranged. Also, depending on the music structure, for example, the effect setting unit 116 sets a dramatic effect in the hook, a normal effect in a normal melody and a mild effect in the bridge such that effects are set with changes.

At the time of setting these expected effects, the effect setting unit 116 may randomly select an effect from multiple effects even in the same condition, instead of selecting the same effect at all times in the same condition. This is because, in a case where the user creates a slide show many times, there are many cases where it is better to create a different slide show every time instead of creating the same slide show at all times.

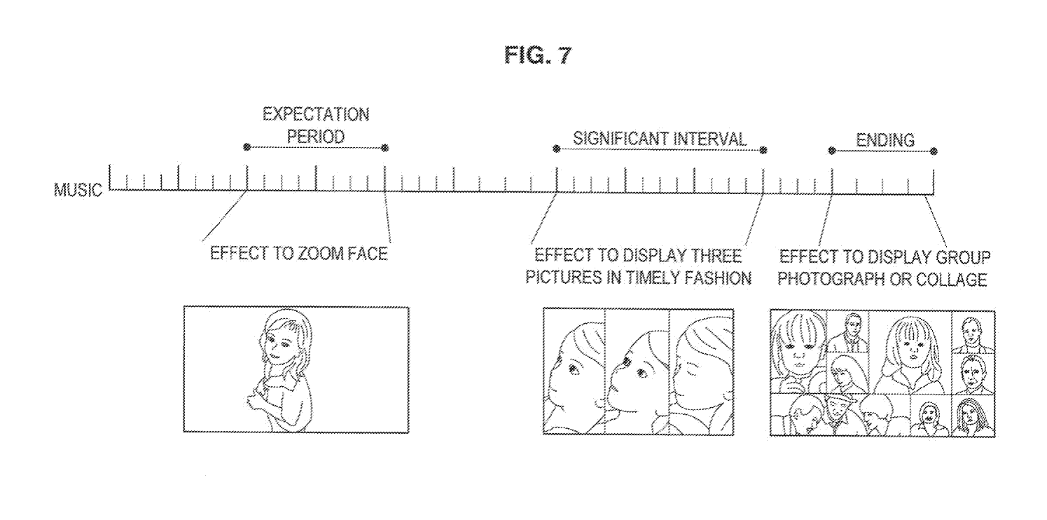

FIG. 7 is an explanatory diagram illustrating an example of setting an expected effect in the effect setting unit 116. FIG. 7 illustrates a state where the effect interval setting unit 108 sets three effect intervals of an expected interval, significant interval and ending, and, with respect to each effect interval, the effect setting unit 116 sets an effect of zooming a face, an effect of displaying three pictures in a timely fashion and an effect of displaying a group photograph or collage.

Here, there is a case where, with respect to one item of music played in a slide show or a playback time of the slide show such as 30 seconds corresponding to part of the music, it is difficult to display all images input in the image processing apparatus 100. In such a case, it is requested to select a requested number of images from the input image group.

Further, in many cases, a slide show is requested by the user to display images in order of the shooting date and time, and, if a requested number of images are extracted from the head and displayed in response to such a request, there is a case where the end part of the input image group is not shown.

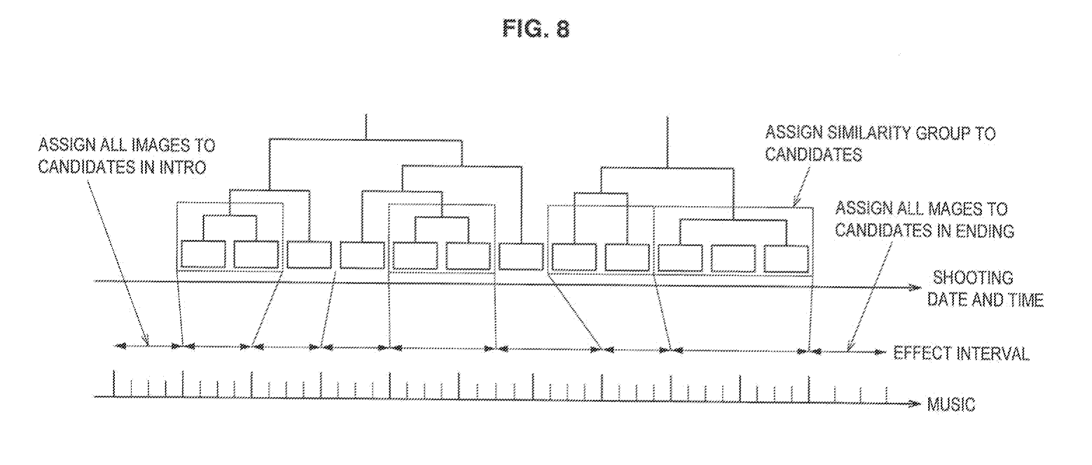

Therefore, the image candidate assigning unit 110 may perform processing of determining which image is assigned to an effect interval set in the effect interval setting unit 108. FIG. 8 is an explanatory diagram illustrating an example of processing of assigning images to effect intervals in the image candidate assigning unit 110. FIG. 8 illustrates an example of assigning images to effect intervals using a formed tree as illustrated in FIG. 6.

As illustrated in FIG. 8, the image candidate assigning unit 110 compares an image group tree prepared in advance and the whole slide show, and performs processing of determining which image is assigned to which effect interval. This assigned image group will be referred to as “selective image candidates” in a certain effect interval.

At the time of assigning the image candidates to the effect intervals, the image candidate assigning unit 110 may equally assign them to each effect interval in order of the shooting date and time or according to a ratio of seconds of the effect intervals. Also, the image candidate assigning unit 110 may perform an assignment so as to satisfy the numbers of images requested for expected effects set in the effect intervals. However, regarding effect intervals for selecting images from the all images regardless of the temporal sequence of shooting date and time, such as the intro and the ending, it is desirable that the image candidate assigning unit 110 specially uses the all images as image candidates.

Also, at the time of assigning the image candidates to the effect intervals in various ways, it is desirable that the image candidate assigning unit 110 assigns larger groups in the tree structure to the effect intervals. For example, in a case where the number of similarity groups is larger than the number of effect intervals, the image candidate assigning unit 110 assigns image candidates in units of the similarity groups, and, in a case where it is possible to perform an assignment by more groups, the assignment is performed in units of the groups. This is because, when images actually displayed in a slide show are determined later, in a case where it is requested to prevent less relevant pictures from being displayed at the same time or it is requested to intentionally display similar pictures in a continuous manner, such images become likely to be selected.

By contrast, in a case where there are a smaller number of input images with respect to the length of music, it is possible to assign the same image to a plurality of effect intervals in an overlapping manner. However, in this case, the same picture repeatedly appears in different effects, and, as a result, the quality of the slide show may degrade. In this case, the slide-show quality deciding unit 122 described later may perform processing of causing the effect interval setting unit 108 to set effect intervals so as to, for example, reset longer effect intervals (i.e. a smaller number of effect intervals), or causing the playback interval selecting unit 106 to shorten the playback intervals of played music.

The image selecting unit 118 selects an image displayed by the effect set in each effect interval by the effect setting unit 116, from images assigned to each effect in the image candidate assigning unit 110.

The effect resetting deciding unit 120 decides whether it is possible to realize an expected effect by the image selected in the image selecting unit 118. The effect resetting deciding unit 120 determines whether it is possible to realize an expected effect, depending on whether the number of pictures is enough, there is a requested number of faces and there is a requested number of similar images.

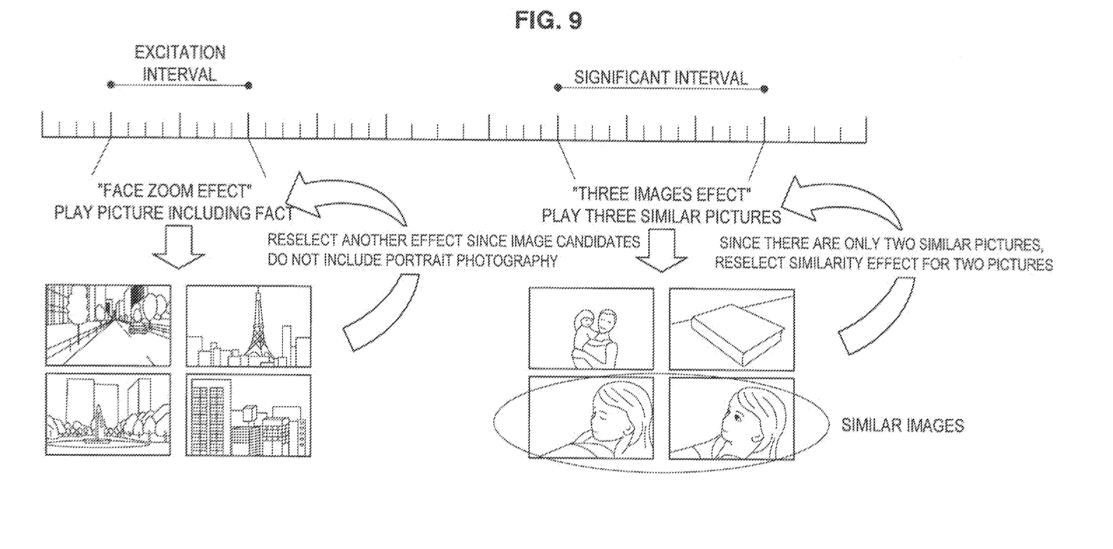

FIG. 9 is an explanatory diagram illustrating an example of resetting effects. In a certain excitation interval, an effect of zooming a face is expected and the effect setting unit 116 sets the effect, but, since there is no picture including a face among the candidate images assigned by the image candidate assigning unit 110, the effect resetting deciding unit 120 causes the effect setting unit 116 to reset another effect. Also, in a certain significant interval, the effect setting unit 116 sets an effect requesting three similar images, but, since there are only two similar images in the candidate images, the effect resetting deciding unit 120 causes the effect setting unit 116 to reset an effect using two similar images instead.

As in the following example, in a case where the effect resetting deciding unit 120 causes the effect setting unit 116 to reset an effect, there may be provided a rule of resetting an effect closer to the original effect. This is done in order to make an atmosphere closer to the first expected atmosphere as the whole slide show as much as possible.

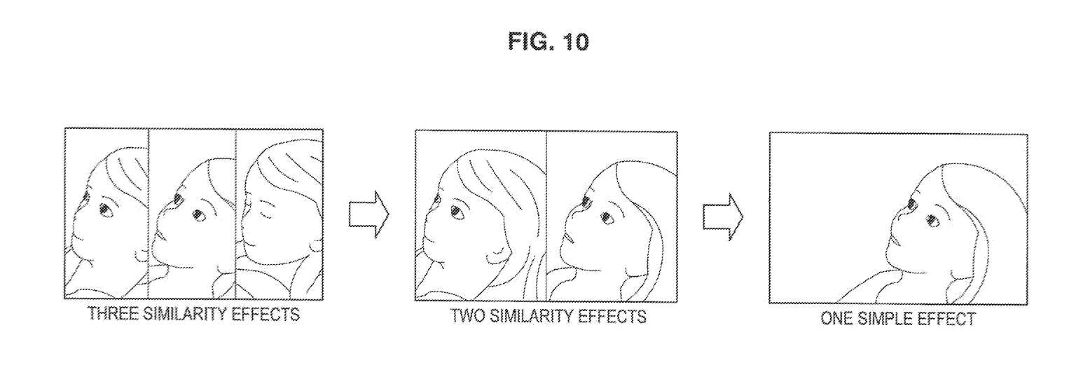

FIG. 10 is an explanatory diagram illustrating an example of reset effects. The reset effects are determined in advance with the ease of conditions as to whether there is a face and whether there is a similar image, in the direction of reducing the number of pictures, a requested number of faces and a requested number of similar images. FIG. 10 illustrates an example where, although an effect of displaying three similar images is set first, since the conditions are not satisfied, an effect of displaying two similar images is set next, but, since the conditions are not satisfied, an effect of displaying one simple image is set.

However, even in a case where a requested number of candidate images are not satisfied with respect to an expected effect, an effect resetting may not be intentionally performed. For example, by a composition analysis technique, at the time of actually playing a slide show, it is also possible to show as if there are a plurality of pictures, from one picture. Therefore, even if a requested number of images are not satisfied, it is possible to check whether it is possible to realize an expected effect, by referring to an image feature amount. A method of cutting out a display range using the composition analysis technique will be described later.

The slide-show quality deciding unit 122 decides the total quality of the slide show from an effect set in the effect setting unit 116 and an image selected in the image selecting unit 118. Especially, when the effect resetting deciding unit 120 resets an effect, the slide-show quality deciding unit 122 decides the total quality of the slide show again from the reset effect and the image selected in the image selecting unit 118.

As a result of resetting effects in individual effect intervals as above by the effect resetting deciding unit 120, there may occur a case where a linkage between consecutive effects becomes bad, effects used in the whole slide show are biased or the number of used images is too small. Therefore, in a case where at least one effect is reset, the slide-show quality deciding unit 122 checks, for example, a linkage between consecutive effects, the bias of used effects or a ratio of the used image number to a parameter.

In a case where the slide-show quality deciding unit 122 decides that the linkage between consecutive effects is bad, it is possible to reset the effects, but, in a case where the effects are reset, the same check is performed again. As a result, in a case where the slide-show quality deciding unit 122 decides that it is not possible to maintain the slide-show quality by the reset effects (e.g. effects are too biased or the number of used images is too small with respect to the parameter), it returns to processing of changing the assignment of images assigned by the image candidate assigning unit 110 and further causing the effect interval setting unit 108 to change the setting of effect intervals. Thus, by recursively performing a creation of a slide show, the image processing apparatus 100 recursively determines an optimal combination of music and images, thereby improving the quality of the slide show.

The image selecting unit 118 selects images actually displayed depending on image effects from candidate images, based on the effect intervals, applied image effects and displayed image candidates in the slide show, which are recursively set.

The image selecting unit 118 may use the following methods depending on the effects, at the time of selecting a requested number of images from the candidate images.

(1) Random selection from candidate images
(2) Selection from candidate images chronologically
(3) Selection of image including face preferentially
(4) Selection of similar image
(1) Random Selection from Candidate Images

This method is used in a case where, when displaying a plurality of images in an effect, the selected images are not specifically requested to be associated with each other. For example, it is used in a case where, in the intro or the ending, many items of images are displayed from the all input images.

(2) Selection from Candidate Images Chronologically

This method is used in a case where, when displaying a plurality of images in an effect, images of the shooting dates and times separated as much as possible are requested to be selected. For example, in a case where it is requested to select three images from the candidate images, the image selecting unit 118 divides the candidate images into three by their shooting dates and times, and selects one image from each of the divided image groups. By this means, it is possible to perform image selection such that similar images are less likely to be displayed. Here, at the time of selecting images, images of the most separated shooting dates and times may be selected or they may be selected at random from the divided image groups.

### (3) Selection of Image Including Face Preferentially

This method is used in the case of using an effect focusing a face. In a case where there are a requested number of images including a face among the candidate images, the image selecting unit 118 selects the requested number of images from them, and, in a case where the number of images including a face is smaller than the requested number of images, the image selecting unit 118 selects images including a face and further selects images to compensate for the shortfall from the remaining images. Here, at the time of selecting images, the image selecting unit 118 may select an image including a larger face or randomly select the requested number of images from the images including a face.

### (4) Selection of Continuous Images in Similarity Group

This method is used in a case where similar images are intentionally displayed. For example, in the case of an effect to sequentially turn over a plurality of images like a cutoff animation, it is effective if images taken by a camera action mode or the like are continuously displayed. To realize such an effect, the image selecting unit 118 selects a requested number of images of consecutive shooting dates and times from an image group designated as the identical similarity group by an image analysis result. In a case where there is not the number of similarity groups equal to or larger than a requested number, the image selecting unit 118 may select the requested number of consecutive images from the image candidates. Also, regarding which similarity group is selected, a similarity group with the largest number of images may be used or a random similarity group may be selected.

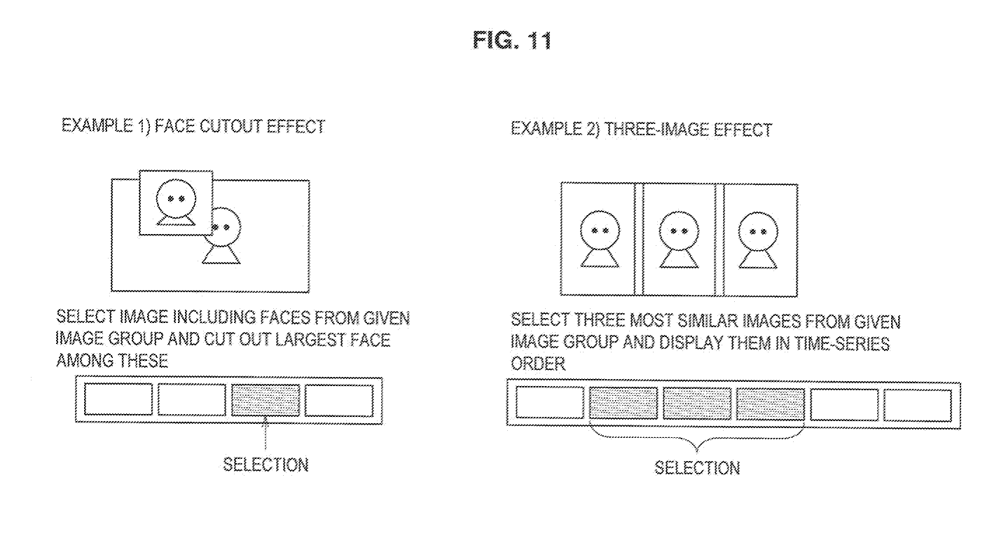

FIG. 11 is an explanatory diagram illustrating an example of the image selecting unit 118 selecting an image from candidate images using the above selection methods. FIG. 11 illustrates two examples. The first example shows that, in a case where an effect set in an effect interval of the image selection target is a face cutting effect to cut and display a face part from an image, the image selecting unit 118 selects an image including a face from a given image group and cuts the largest face in it by the effect. Also, the second example shows that, in a case where an effect set in an effect interval of the image selection target is a three-image effect to continuously display three images, the image selecting unit 118 selects three most similar images from a given image group and display them in time-series order.

Thus, the image selecting unit 118 selects an image suitable to an image effect set in an effect interval of the image selection target from candidate images.

As described in the setting of an expected effect by the effect setting unit 116, the image selecting unit 118 may include some random element at the time of using the image selection methods. By including a random element, different pictures appear every time when the user creates a slide show many times, and therefore it is possible to give a different impression.

The display range cutout unit 124 cuts out a display range of an image selected by the image selecting unit 118. As described above, although an image to be displayed and an applied image effect are determined in each effect interval, there is a case where a given image effect is requested to not only display one image as is but also display it on an area of a specific aspect ratio. For example, in a case where an image with an original aspect ratio of 4 to 3 is requested to be displayed with an aspect ratio of 16 to 9 in the case of slide show playback or displayed with aspect ratios of 4 to 3 and 3 to 4, it is requested to cut a requested display rang from the original image in some way.

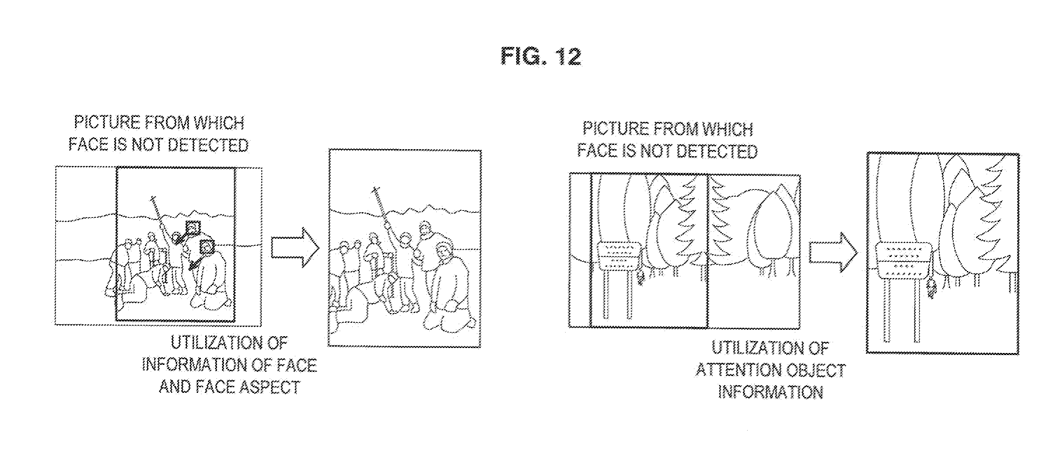

In a case where it is requested to display an image in an area with a specific aspect ratio, by using the composition analysis technique, the display range cutout unit 124 can cut an area with an arbitrary aspect ratio in various conditions. FIG. 12 is an explanatory diagram illustrating an example of cutting out a display range by the display range cutout unit 124. For example, as illustrated in FIG. 12, in a case where a display range with a vertically long aspect ratio is requested from a horizontally long image and a face is detected in a selected image, the display range cutout unit 124 cuts out an optimal area using information of face positions and aspects, and, in a case where no face is detected, it can similarly cut an optimal area using attention object information.

Methods of cutting out a display area using a composition analysis include: a circle composition to cut it with respect to a face or attention area; a three-division composition which is generally a beautiful composition as a picture; a zoom-up composition to cut a face or attention area as large as possible; and a diagonal composition to show a parent-child picture clearly. Using these display area cut methods, the display range cutout unit 124 can perform cutting by various compositions according to the theme or effect type.

Also, in the above effect resetting, even in a case where the number of candidate images is not less than a requested number for an expected effect, a case has been described where an effect resetting is not intentionally performed. In this case where the number of candidate images is not less than the requested number for the expected effect, by cutting out an image using the composition analysis technique, the display range cutout unit 124 can realize an effect as if there are a plurality of pictures.

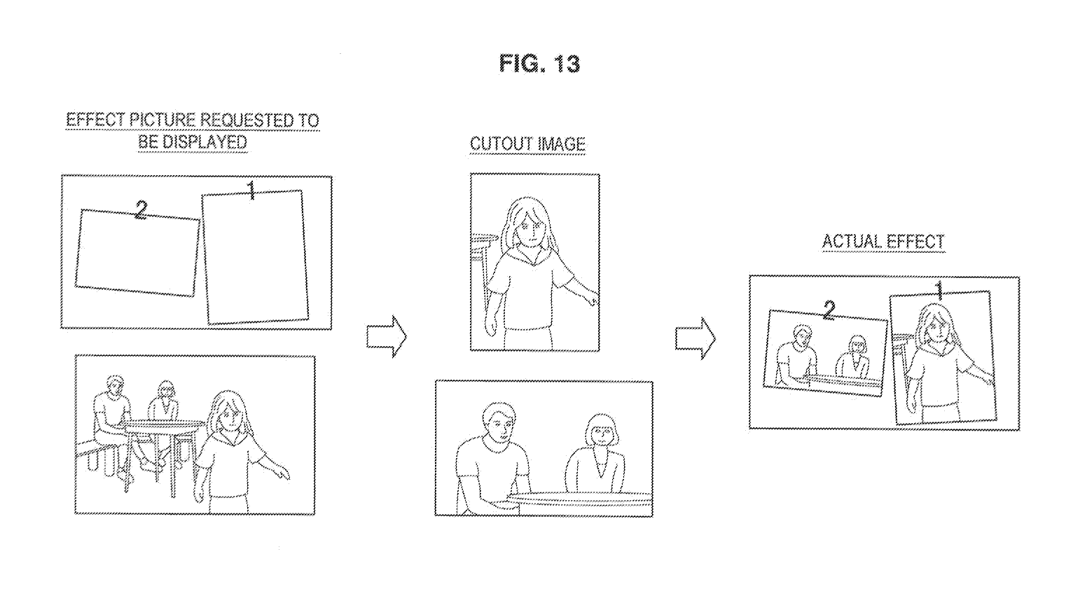

FIG. 13 is an explanatory diagram illustrating an example of the display range cutout unit 124 realizing an effect of using multiple images from one image by cutting out the images using the composition analysis technique. FIG. 13 exemplifies a case where, although two pictures are requested in a certain effect to be displayed, an image selected by the image selecting unit 118 is only one. In such a case, using the composition analysis technique, the display range cutout unit 124 cuts out a part photographing a child and a part photographing parents, from one image, and apply them to an effect. By this means, it is possible to realize an effect as if there are a plurality of pictures.

Naturally, in the case of an effect that is not requested to be displayed in an area with a specific aspect ratio, the cutout processing by the display range cutout unit 124 may be skipped.

The timing adjusting unit 126 adjusts the effect display timing. In the above explanation, since a displayed image and an image effect are determined in each effect interval, the timing adjusting unit 126 adjusts the display timing of the determined effect. Each effect has parameters “show,” “start,” “end” and “hide” disclosed in Japanese Patent Laid-Open No. 2011-181103, for example. The meanings of these parameters are as follows.

show: timing at which an effect activation period starts and an initial state is displayed
start: timing at which an effect mainly starts animation
end: timing at which an effect mainly ends animation
hide: timing at which an effect activation period ends and is cancelled

For example, the timing adjusting unit 126 causes “start” and “end” to match the start and end of an effect interval, sets “show” one beat before “start” and sets “hide” one beat after “end,” thereby performing setting so as to perform animation while these effects overlap by one beat.

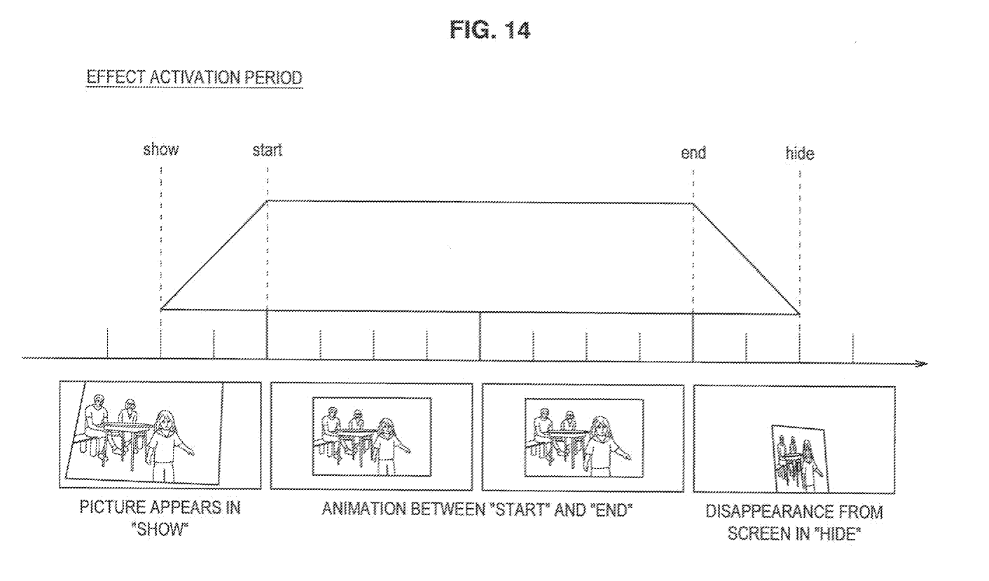

FIG. 14 is an explanatory diagram illustrating an example of animation in which the parameters are set by the timing adjusting unit 126. The trapezoidal shape illustrated in FIG. 14 illustrates a state where images are displayed by set effects. That is, pictures start to appear at the timing of “show” and are clearly displayed at the timing of “start,” animation by an effect is performed between “start” and “end,” the pictures start to gradually disappear between “end” and “hide,” and the pictures completely disappear at the timing of “hide.”

Also, depending on the effect (for example, effect to sequentially slide pictures in one effect), there is a case where the timing of animation is requested to be arbitrarily set. The timing adjusting unit 126 can set a parameter called “key frame” to this effect and perform detailed timing adjustment on the animation in this effect.

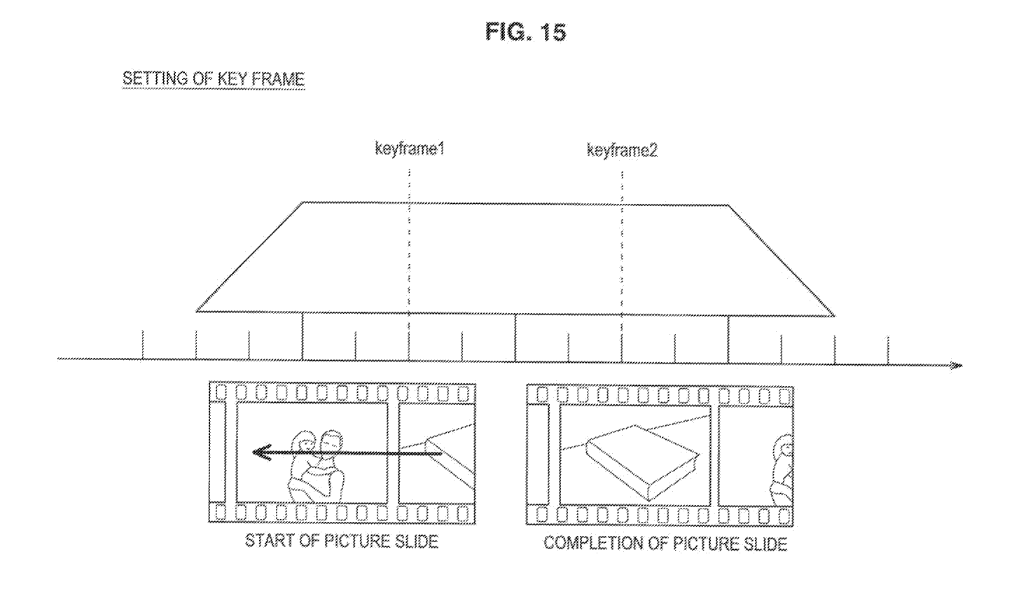

FIG. 15 is an explanatory diagram illustrating an example of animation in which parameters of key frames are set by the timing adjusting unit 126. FIG. 15 illustrates an effect which is set such that a picture starts at the timing of “keyframe1” and the picture slide ends at the timing of “keyframe2.”

The slide show outputting unit 128 outputs a slide show in which the effect display timing is adjusted by the timing adjusting unit 126, as one file.

Although a preparation for basic information to realize a slide show has been completed in the timing adjusting unit 126, the image processing apparatus 100 may set information to decorate the slide show before the slide show outputting unit 128 outputs the slide show as one file. For example, by detecting main colors of pictures used in the slide show, it is possible to provide a unique expression depending on the set theme. This color detection may be performed by the slide show outputting unit 128.

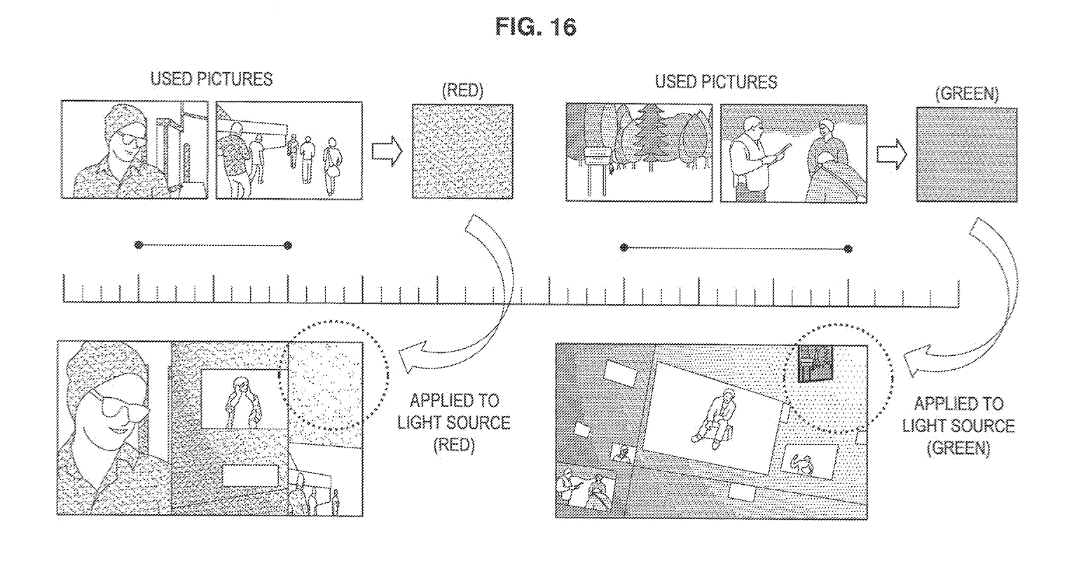

FIG. 16 is an explanatory diagram illustrating a setting example of information to decorate a slide show. The example illustrated in FIG. 16 realizes an improvement of the visual quality of the slide show by estimating the main color of the picture group in each effect interval and changing the color shade of a light source according to the main color. For example, since the red color is mainly used many times in pictures on the left side of FIG. 16, the slide show outputting unit 128 detects the red color as a representative color in the interval and provides an effect using the red color as a light source. Also, for example, since the green color is mainly used many times in pictures on the right side of FIG. 16, the slide show outputting unit 128 detects the green color as a representative color in the interval and provides an effect using the green color as a light source.

The configuration of the image processing apparatus 100 according to an embodiment of the present disclosure has been explained above. Next, operations of the image processing apparatus 100 according to an embodiment of the present disclosure will be explained.

### [Operations of Image Processing Apparatus]

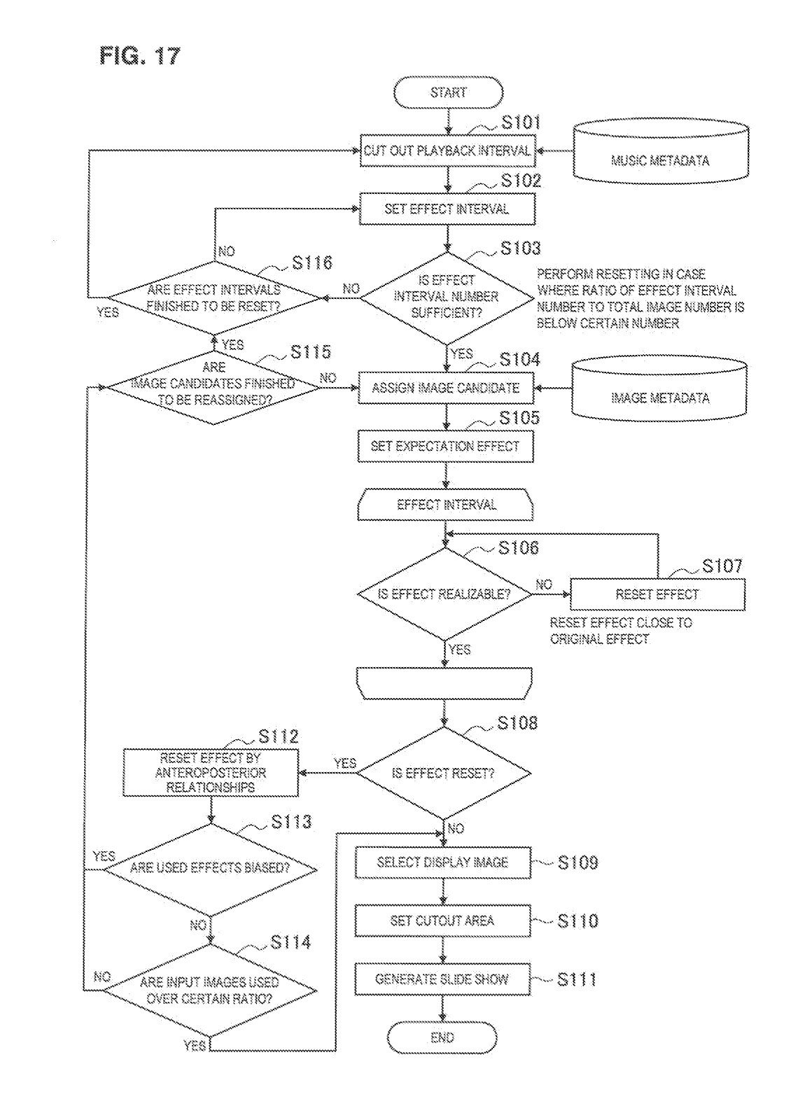

FIG. 17 is a flowchart illustrating operations of the image processing apparatus 100 according to an embodiment of the present disclosure. The flowchart illustrated in FIG. 17 illustrates operations at the time of generating a slide show by the image processing apparatus 100 according to an embodiment of the present disclosure. In the following, the operations of the image processing apparatus 100 according to an embodiment of the present disclosure will be explained using FIG. 17.

At the time of generating a slide show by the image processing apparatus 100, first, the image processing apparatus 100 cuts out a playback interval of music played at the time of displaying the slide show, using music metadata held in the music metadata holding unit 104 (step S101). The cutout of the playback interval is performed by the playback interval selecting unit 106.

When the music playback interval is cut out in above step S101, the image processing apparatus 100 subsequently sets effect intervals from the music playback interval (step S102). The setting of the effect intervals is performed by the effect interval setting unit 108.

When the setting of the effect intervals is performed in above step S102, the image processing apparatus 100 subsequently decides whether the number of effect intervals set in above step S102 is sufficient (step S103). This processing is performed by the effect interval setting unit 108, and whether the number of effect intervals is sufficient may be decided depending on whether a ratio of the effect interval number to the total image number is equal to or above a certain number.

In a case where the decision result in above step S103 shows that the number of effect intervals is sufficient, the image processing apparatus 100 subsequently assigns image candidates to the effect intervals set in above step S102 (step S104). The assignment of the image candidates is performed by the image candidate assigning unit 110, and, using the image metadata held in the image metadata holding unit 114, the image candidates are assigned to the effect intervals.

When the image candidates are assigned to the effect intervals in above step S104, the image processing apparatus 100 subsequently sets an effect (i.e. expectation effect) expected with respect to each set effect interval (step S105). The setting of the expectation effect with respect to each effect interval is performed by the effect setting unit 116.

When the expectation effect with respect to each effect interval is set in above step S105, the image processing apparatus 100 subsequently decides whether it is possible to realize the set expectation effects by the assigned images in the all effect intervals (step S106). This decision as to whether to be able to realize them is performed by the effect resetting deciding unit 120.

If the decision result in above step S106 shows that there is an unrealizable effect, the image processing apparatus 100 resets an effect with respect to an effect interval in which the unrealizable effect is set (step S107). This effect resetting is performed by the effect setting unit 116.

If there is no unrealizable effect with respect to the all effect intervals, the image processing apparatus 100 subsequently decides whether the effect resetting in above step S107 is performed (step S108). The decision as to whether this effect resetting is performed is performed by the slide-show quality deciding unit 122.

If the decision result in above step S108 shows that the effect resetting is not performed in above step S107, the image processing apparatus 100 subsequently selects an image displayed by the effect set in each effect interval (step S109). This display image selection is performed by the image selecting unit 118.

If the image displayed by the effect set in each effect interval is selected in above step S109, the image processing apparatus 100 subsequently sets a cutout area of the image selected in above step S109 (step S110). The cutout area setting of the selected image is performed by the display range cutout unit 124. Also, if it is not requested to cut out a display range of the image selected in above step S109, the processing in step S110 may be skipped.

If the image cutout area is set in above step S110, the image processing apparatus 100 subsequently generates a slide show using the set effect intervals, the effect set in each effect interval and the image selected in each effect (step S111). The generation of the slide show is performed by the slide show outputting unit 128, and it is possible to use an arbitrary file format as a file format to output the slide show. Also, the image processing apparatus 100 may adjust the effect display timing before the slide show generation processing in step S111. This effect display timing adjustment is performed by the timing adjusting unit 126.

Meanwhile, if the decision result in above step S108 shows that the effect resetting is performed at least one time in above step S107, the image processing apparatus 100 subsequently performs the effect resetting by anteroposterior relationships (S112). To be more specific, the slide-show quality deciding unit 122 checks the whole slide show and instructs the resetting to the playback interval selecting unit 106, the effect interval setting unit 108, the image candidate assigning unit 110 and the effect setting unit 116.

When the effect resetting by anteroposterior relationships in above step S112 is performed, the image processing apparatus 100 subsequently decides whether used effects are biased (step S113). The decision as to whether the effects are biased is performed by the slide-show quality deciding unit 122, and whether the effects are biased is decided using decision criteria such as whether effects to provide a similarity effect are continuously used and whether effects to zoom in a face are continuously used.

If it is decided from the decision result in above step S113 that the used effects are biased, the image processing apparatus 100 subsequently decides whether images input in the image processing apparatus 100 for the purpose of creating a slide show are used at a constant ratio (step S114). This decision is performed by the slide-show quality deciding unit 122. Also, in the present disclosure, this decision processing in step S114 may be skipped.

If it is decided from the decision result in above step S114 that the images are used at the constant ratio, the image processing apparatus 100 shifts to the display image selection processing in step S109. Meanwhile, in a case where it is decided from the decision result in above step S113 that the used effects are biased or where it is decided from the decision result in above step S114 that the images are not used at the constant ratio, the image processing apparatus 100 decides whether image candidates have been reassigned to the effect intervals (step S115). If the image candidates have not been reassigned to the effect intervals, the image processing apparatus 100 performs processing subsequent to the image candidate assignment processing in step S104. Meanwhile, if the image candidates have been reassigned to the effect intervals, the image processing apparatus 100 decides whether the effect intervals have been reset (step S116). If the effect intervals have been reset, the image processing apparatus 100 performs processing subsequent to the playback interval cutout processing in step S101, and, if they have not been reset, the image processing apparatus 100 performs processing subsequent to the effect interval setting processing in step S102.

Thus, the image processing apparatus 100 according to an embodiment of the present disclosure can improve the slide-show quality by recursively and automatically performing playback interval selection of music played according to the slide show, the effect interval setting, the image candidate assignment, the effect setting and the selection of images displayed by effects.

### [Setting of Effect Intervals and Effects Using Music Analysis Result]

Here, using an example, a further explanation will be given to setting processing of effect intervals and effects using a music analysis result. The image processing apparatus 100 according to the present embodiment performs the effect interval setting and the effect setting using a music analysis result as described above.

The effect interval setting unit 108 detects a non-diatonic chord, a dominant stop and a position in which the chords is often switched, from a music key and chord progression acquired as a result of the music analysis, and acquires the time information. Also, the effect interval setting unit 108 acquires a partial modulation position or a modulation position from the music analysis result.

From the music analysis result, the effect setting unit 116 decides whether music played according to the slide show is major or the music is minor, and selects a theme. According to the melody decision result, the effect setting unit 116 selects effect candidates including multiple effects. For example, the effect setting unit 116 selects a happy effect group in the case of major music and selects an unhappy effect group in the case of minor music. Here, the image processing apparatus 100 assigns a parameter indicating to which feature each effect is suitable, and holds the parameter.

Subsequently, the effect setting unit 116 selects an effect suitable to a feature from the effect candidates and performs setting such that the effect is performed at appropriate time or timing.

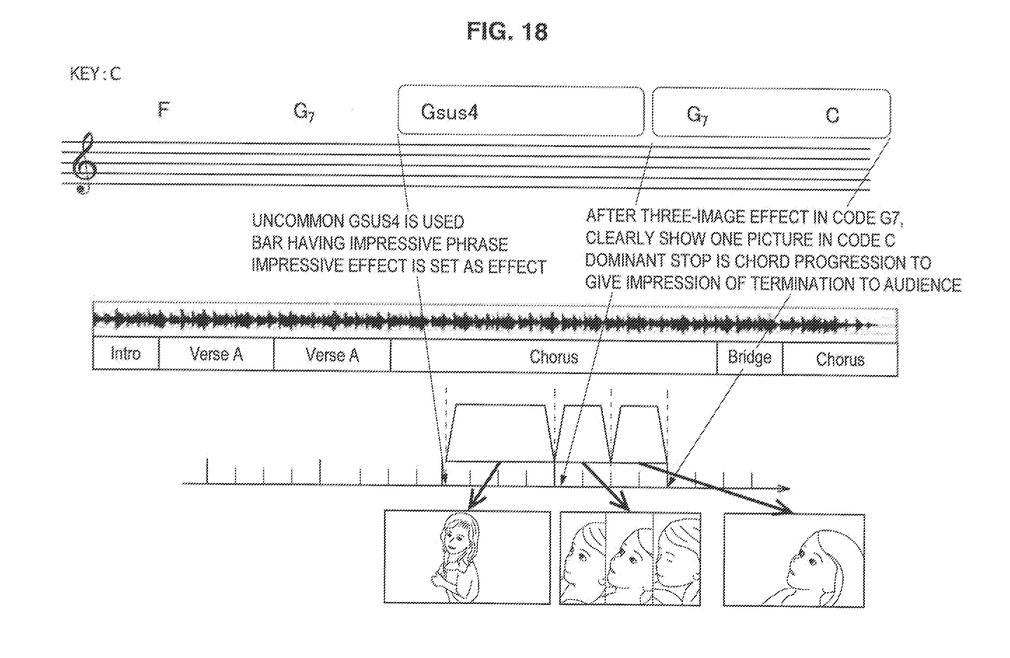

FIG. 18 is an explanatory diagram illustrating an example of selecting an effect suitable to music in the image processing apparatus 100 according to the present embodiment. FIG. 18 illustrates a case where a result of analyzing music played according to a slide show shows that the key is a C major chord and the chord changes in order from F, G7, Gsus4, G7 to C.

In the music example illustrated in FIG. 18, an uncommon Gsus4 is used as a non-diatonic chord and a bar using this chord is a bar having an impressive phrase. Therefore, in an effect interval using this Gsus4, the image processing apparatus 100 selects an effect that is likely to impress people who look at the slide show.

Also, in the music example illustrated in FIG. 18, after the non-diatonic chord, the chord progresses from G7 (V) to C (I) by four levels and the cadence dominant stop is used. Since the dominant stop is chord progression to give an impression of termination to an audience, it is effective to use a significant effect in the slide show. Therefore, the image processing apparatus 100 adopts an effect using three pictures in an effect interval using G7 and adopts an effect to clearly show one picture in an effect interval using C.

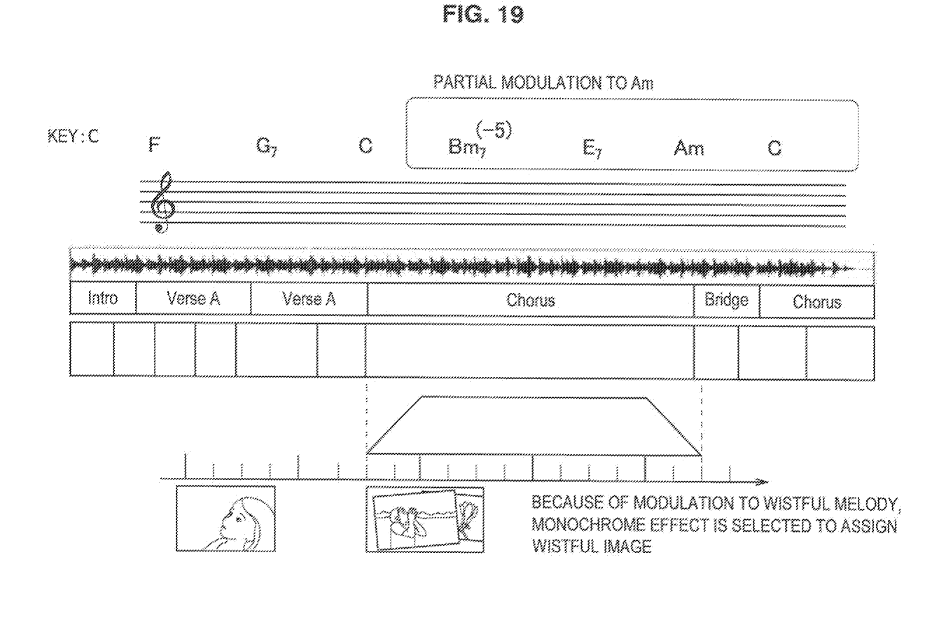

Another example will be explained. FIG. 19 is an explanatory diagram illustrating an example of selecting an effect suitable to music in the image processing apparatus 100 according to the present embodiment. FIG. 19 illustrates a case where a result of analyzing music played according to a slide show shows that the key is a C major chord and the chord changes in order from F, G7, C, Bm7b5, E7, Am to C.

The music example illustrated in FIG. 19 shows partial modulation to Am. Since Am is a chord to give a wistful impression, the image processing apparatus 100 sets an effect to provide a monochrome display in an effect interval in which the chord progresses in order from Bm7b5, E7, Am to C. By this means, in a part with partial modulation to Am, it is possible to assign a wistful image to the slide show.

Thus, by setting a suitable effect according to chord progression, the image processing apparatus 100 according to the present embodiment can create a slide show to display pictures with effects suitable to the melody. Also, as described above, in order to set a suitable effect according to chord progression, the image processing apparatus 100 assigns a parameter indicating to which feature each effect is suitable, and holds the parameter.

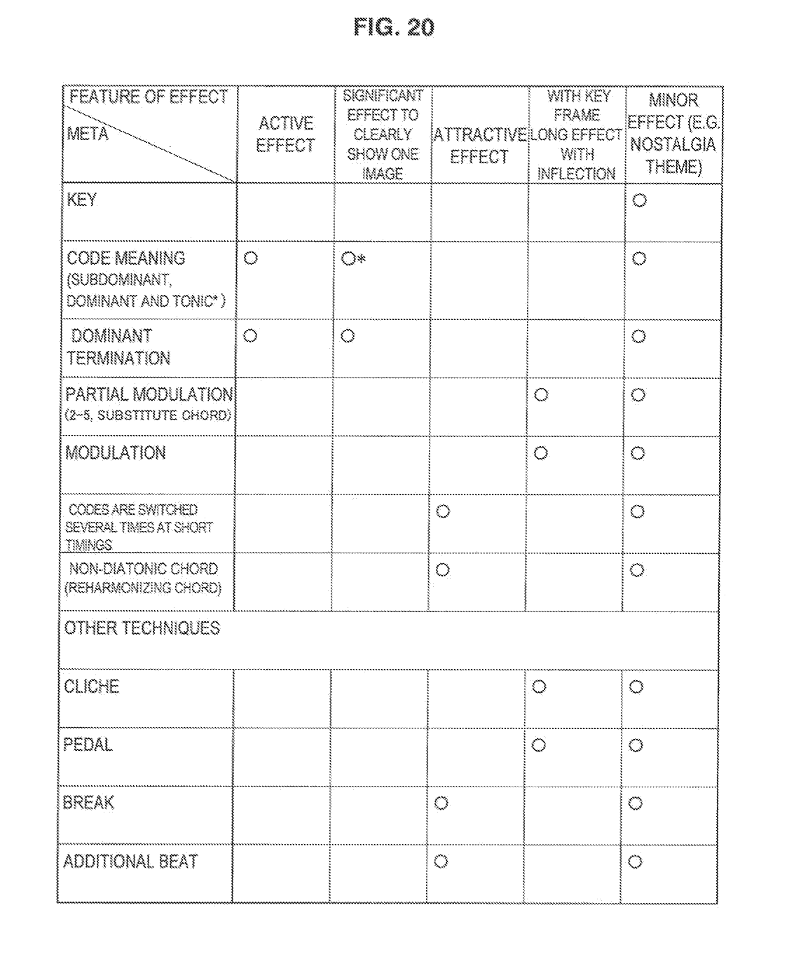

FIG. 20 is an explanatory diagram illustrating an example of correspondence relationships between melodies and effects. Thus, by assigning correspondence relationships between music features and effects as parameters and holding these parameters, the image processing apparatus 100 can create a slide show to display pictures by effects suitable to the melody.

For example, in a part in which the chord often switches at short timings (e.g. in bar units), the parameters are assigned to the effects such that attractive effects are used. Also, for example, in a dominant stop part, the parameters are assigned to the effects such that an active effect, an effect including a significant effect activation to clearly show one picture, and a significant effect to clearly show one picture are used.

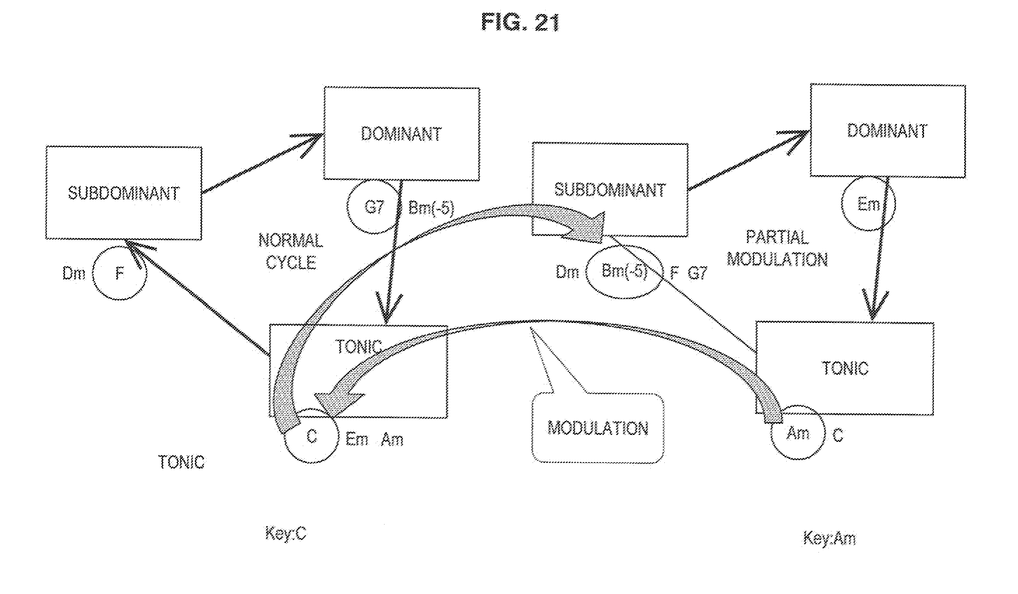

Next, a detection example of partial modulation will be explained. FIG. 21 is an explanatory diagram illustrating a detection example of partial modulation by the image processing apparatus 100. The chord normally includes the tonic, the subdominant and the dominant, and, in a case where the key is a C major chord, the tonic includes C, Em and Am, the subdominant includes Dm and F, and the dominant includes G7, Bm and Bm(−5). Also, in a case where the key is Am (A minor chord), the tonic includes Am and C, the subdominant includes Dm, Bm(−5), F and G7, and the dominant includes Em.

Here, in the case of changes in order from F, G7, C, Bm(−5), Em, Am to C, partial modulation to Am is found in the part of C and Bm(−5). This is because, in a case where the key is the C major chord, although it is natural to progress to F since the subdominant is F, it progresses to B(−5) which is the subdominant in a case where the key is Am.

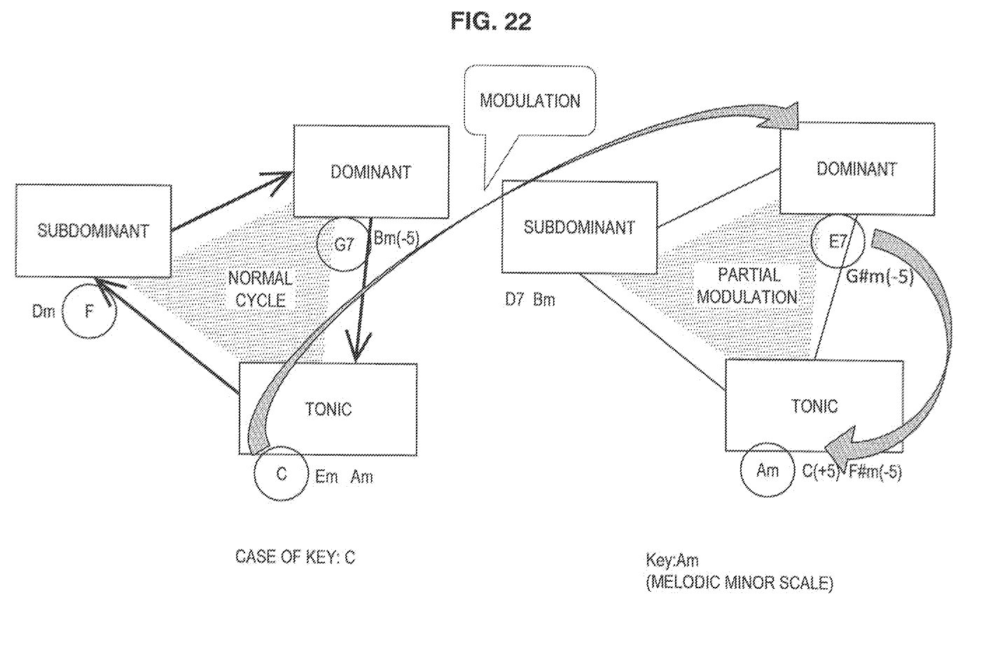

FIG. 22 is an explanatory diagram illustrating another detection example of partial modulation by the image processing apparatus 100. In a case where the key is Am (A minor chord) and in the case of a melodic minor scale, the tonic includes Am, C(+5) and F#m(−5), the subdominant includes Dm and Bm, and the dominant includes Em and G#m(−5).

Here, in the case of changes in order from F, G7, C, E7 to Am, partial modulation to Am is found in the changes of C and E7. Also, in the example illustrated in FIG. 22, the image processing apparatus 100 can detect partial modulation corresponding to a wistful image.

The image processing apparatus 100 according to the present embodiment can automatically select an effect according to the melody of arbitrary music, for example, a pop effect for happy music and a nostalgia effect for unhappy music. For example, the image processing apparatus 100 can select an impressive effect between beats using a non-diatonic chord which is an impressive melody in music, and, since it is likely to become a hook interval, in the case of the hook interval, select a dramatic image impact to incur a sense of expectation and stop at the hook interval.

Since the image processing apparatus 100 according to the present embodiment can detect a part with an impression of termination by music analysis, in a bar with a relaxing chord sound, it is possible to assign and maintain a significant small-change effect to clearly show one picture, thereby varying the pace of the slide show.

Since the image processing apparatus 100 according to the present embodiment can detect an impressive and exciting music part such as partial modulation or modulation by music analysis, it is possible to select an effect that simultaneously excites images according to the excitation of music and that is the biggest scene of the slide show.

Also, since the image processing apparatus 100 according to the present embodiment can detect a bar in which the chord often switches in beat units by music analysis, in such a bar, it is possible to assign an effect in which pictures are often switched, thereby matching music with image effects.

### <2. Summary>

As described above, the image processing apparatus 100 according to an embodiment of the present disclosure sets effect intervals and effects suitable to the effect intervals, from music metadata acquired by analyzing music. At the time of setting the effect intervals, the image processing apparatus 100 extracts characteristic parts in the music. Also, the image processing apparatus 100 assigns image data to each effect interval, decides whether the assigned image data satisfies effect conditions, and, if the assigned image data satisfies effect conditions, determines an image displayed by the effect, and, if the assigned image data does not satisfy effect conditions, recursively resets the image data assignment, the effect setting and the effect interval setting.

Also, if the effect setting is performed again, the image processing apparatus 100 decides the effect consistency between an effect interval in which the effect resetting is performed and a different effect interval in which the effect resetting is not performed. As a result of the effect consistency decision, if there is an inconsistent effect interval, the image processing apparatus 100 causes an effect resetting to be further performed so as to be consistent.

By this means, the image processing apparatus 100 according to an embodiment of the present disclosure can automatically create a slide show from music metadata acquired by analyzing music and image metadata acquired by analyzing image data, and improve the quality of the generated slide show.

Also, the operations of the image processing apparatus 100 according to an embodiment of the present disclosure may be performed by hardware or software. In the case of performing them by software, for example, a CPU and other control apparatuses set in the image processing apparatus 100 may read a computer program stored in a storage medium such as ROM set inside the image processing apparatus 100 and sequentially perform the operations.

Also, each component of the image processing apparatus 100 according to an embodiment of the present disclosure may be mounted on any hardware as long as the hardware can transmit/receive mutual information to/from each other via a network. Also, processing implemented by a certain processing unit may be realized by one hardware or by distributed processing by multiple items of hardware.

Although preferred embodiments of the present disclosure have been described above in detail with reference to the accompanying drawings, the present disclosure is not limited to those examples. It is clear that a person who has normal knowledge in the technical field to which the present disclosure belongs can conceive of various variation examples or adjusted examples within a range of technical ideals disclosed in the claims, and it is natural that these belong to the technical field of the present disclosure.

Additionally, the present technology may also be configured as below.

(1) An image processing apparatus including:

an effect interval setting unit setting multiple effect intervals in a predetermined interval to continuously display image data;

an image assigning unit assigning the image data to each of the multiple effect intervals set by the effect interval setting unit;

an effect setting unit setting an effect to each of the multiple effect intervals set by the effect interval setting unit;

an effect resetting deciding unit deciding whether the effect set with respect to each of the multiple effect intervals by the effect setting unit satisfies a condition to realize each effect, using image metadata corresponding to image data assigned by the image assigning unit, and causing the effect setting unit to reset an effect in an effect interval in a case where the effect interval does not satisfy the condition; and

a consistency deciding unit deciding, in a case where the effect resetting deciding unit causes the effect setting unit to reset the effect, a consistency between an effect interval in which the effect is reset and a different effect interval.

(2) The image processing apparatus according to (1), wherein the effect interval setting unit sets an effect interval using music metadata acquired by analyzing music played at a time of displaying the image data.
(3) The image processing apparatus according to (2), wherein the effect interval setting unit extracts a characteristic interval from the music metadata and sets the interval as an effect interval.
(4) The image processing apparatus according to any one of (1) to (3), wherein the effect setting unit sets an effect using music metadata acquired by analyzing music data played at a time of displaying the image data.
(5) The image processing apparatus according to (4), wherein the effect setting unit selects an effect suitable to a feature of the music data played in an effect interval set by the effect interval setting unit.
(6) The image processing apparatus according to any one of (1) to (5), wherein, in a case where there is no consistency between the effect interval in which the effect is reset and the different effect interval, the consistency deciding unit causes the effect setting unit to reset an effect.
(7) The image processing apparatus according to (6), wherein, in a case where there is no consistency between all effect intervals even after the effect setting unit is caused to reset an effect, the consistency deciding unit causes the image assigning unit to reassign image data.
(8) The image processing apparatus according to (6) or (7), wherein, in a case where there is no consistency between all effect intervals even after the effect setting unit is caused to reset an effect, the consistency deciding unit causes the effect interval setting unit to reset an effect interval.
(9) The image processing apparatus according to any one of (6) to (8), further including a playback interval selecting unit selecting a playback interval of music data played at a time of displaying the image data,

wherein, in a case where there is no consistency between all effect intervals even after the effect setting unit is caused to reset an effect, the consistency deciding unit causes the playback interval selecting unit to change a playback interval of the music data played at the time of displaying the image data.

(10) The image processing apparatus according to any one of (1) to (9), further including an image selecting unit selecting an image displayed in the effect interval by an effect set by the effect setting unit, from images assigned to the effect interval by the image assigning unit.
(11) The image processing apparatus according to any one of (1) to (10), further including an image metadata holding unit holding image metadata acquired by analyzing the image data.
(12) The image processing apparatus according to any one of (1) to (11), further including a music metadata holding unit holding music metadata acquired by analyzing music data played at a time of displaying the image data.
(13) An image processing method including:

an effect interval setting operation setting multiple effect intervals in a predetermined interval to continuously display image data;

an image assigning operation assigning the image data to each of the multiple effect intervals set by the effect interval setting operation;

an effect setting operation setting an effect to each of the multiple effect intervals set by the effect interval setting operation;

an effect resetting deciding operation deciding whether the effect set with respect to each of the multiple effect intervals in the effect setting operation satisfies a condition to realize each effect, using image metadata corresponding to image data assigned in the image assigning operation, and causing an effect in an effect interval to be reset in a case where the effect interval does not satisfy the condition; and

a consistency deciding operation deciding, in a case where the effect resetting deciding operation causes the effect setting operation to reset the effect, a consistency between an effect interval in which the effect is reset and a different effect interval.

(14) A computer program that causes a computer to execute:

an effect interval setting operation setting multiple effect intervals in a predetermined interval to continuously display image data;

an effect setting operation setting an effect to each of the multiple effect intervals set by the effect interval setting operation;

an image assigning operation assigning the image data to each of the multiple effect intervals set by the effect interval setting operation;

an effect resetting deciding operation deciding whether the effect set with respect to each of the multiple effect intervals in the effect setting operation satisfies a condition to realize each effect, using image metadata corresponding to image data assigned in the image assigning operation, and causing an effect in an effect interval to be reset in a case where the effect interval does not satisfy the condition; and

a consistency deciding operation deciding, in a case where the effect resetting deciding operation causes the effect setting operation to reset the effect, a consistency between an effect interval in which the effect is reset and a different effect interval.

The present disclosure contains subject matter related to that disclosed in Japanese Priority Patent Application JP 2012-069102 filed in the Japan Patent Office on Mar. 26, 2012, the entire content of which is hereby incorporated by reference.

What is claimed is:

1. An image processing apparatus comprising:
an effect interval setting unit setting multiple effect intervals in a predetermined interval to continuously display image data;
an image assigning unit assigning the image data to each of the multiple effect intervals set by the effect interval setting unit;
an effect setting unit setting an effect to each of the multiple effect intervals set by the effect interval setting unit;
an effect resetting deciding unit deciding whether the effect set with respect to each of the multiple effect intervals by the effect setting unit satisfies a condition to realize each effect, using image metadata corresponding to image data assigned by the image assigning unit, and causing the effect setting unit to reset an effect in an effect interval in a case where the effect interval does not satisfy the condition; and
a consistency deciding unit deciding, in a case where the effect resetting deciding unit causes the effect setting unit to reset the effect, a consistency between an effect interval in which the effect is reset and a different effect interval.

2. The image processing apparatus according to claim 1, wherein the effect interval setting unit sets an effect interval using music metadata acquired by analyzing music played at a time of displaying the image data.

3. The image processing apparatus according to claim 2, wherein the effect interval setting unit extracts a characteristic interval from the music metadata and sets the interval as an effect interval.

4. The image processing apparatus according to claim 1, wherein the effect setting unit sets an effect using music metadata acquired by analyzing music data played at a time of displaying the image data.

5. The image processing apparatus according to claim 4, wherein the effect setting unit selects an effect suitable to a feature of the music data played in an effect interval set by the effect interval setting unit.

6. The image processing apparatus according to claim 1, wherein, in a case where there is no consistency between the effect interval in which the effect is reset and the different effect interval, the consistency deciding unit causes the effect setting unit to reset an effect.

7. The image processing apparatus according to claim 6, wherein, in a case where there is no consistency between all effect intervals even after the effect setting unit is caused to reset an effect, the consistency deciding unit causes the image assigning unit to reassign image data.

8. The image processing apparatus according to claim 6, wherein, in a case where there is no consistency between all effect intervals even after the effect setting unit is caused to reset an effect, the consistency deciding unit causes the effect interval setting unit to reset an effect interval.

9. The image processing apparatus according to claim 6, further comprising a playback interval selecting unit selecting a playback interval of music data played at a time of displaying the image data,
wherein, in a case where there is no consistency between all effect intervals even after the effect setting unit is caused to reset an effect, the consistency deciding unit causes the playback interval selecting unit to change a playback interval of the music data played at the time of displaying the image data.

10. The image processing apparatus according to claim 1, further comprising an image selecting unit selecting an image displayed in the effect interval by an effect set by the effect setting unit, from images assigned to the effect interval by the image assigning unit.

11. The image processing apparatus according to claim 1, further comprising an image metadata holding unit holding image metadata acquired by analyzing the image data.

12. The image processing apparatus according to claim 1, further comprising a music metadata holding unit holding music metadata acquired by analyzing music data played at a time of displaying the image data.

13. An image processing method comprising:
an effect interval setting operation setting multiple effect intervals in a predetermined interval to continuously display image data;
an image assigning operation assigning the image data to each of the multiple effect intervals set by the effect interval setting operation;
an effect setting operation setting an effect to each of the multiple effect intervals set by the effect interval setting operation;
an effect resetting deciding operation deciding whether the effect set with respect to each of the multiple effect intervals in the effect setting operation satisfies a condition to realize each effect, using image metadata corresponding to image data assigned in the image assigning operation, and causing an effect in an effect interval to be reset in a case where the effect interval does not satisfy the condition; and
a consistency deciding operation deciding, in a case where the effect resetting deciding operation causes the effect setting operation to reset the effect, a consistency between an effect interval in which the effect is reset and a different effect interval.

14. A computer program that causes a computer to execute:
an effect interval setting operation setting multiple effect intervals in a predetermined interval to continuously display image data;
an effect setting operation setting an effect to each of the multiple effect intervals set by the effect interval setting operation;
an image assigning operation assigning the image data to each of the multiple effect intervals set by the effect interval setting operation;
an effect resetting deciding operation deciding whether the effect set with respect to each of the multiple effect intervals in the effect setting operation satisfies a condition to realize each effect, using image metadata corresponding to image data assigned in the image assigning operation, and causing an effect in an effect interval to be reset in a case where the effect interval does not satisfy the condition; and
a consistency deciding operation deciding, in a case where the effect resetting deciding operation causes the effect setting operation to reset the effect, a consistency between an effect interval in which the effect is reset and a different effect interval.
